(19) United States
(12) Patent Application Publication
(10) Pub. No.: US 2010/0111229 A1
(43) Pub. Date: May 6, 2010

(54) METHOD AND APPARATUS OF GENERATING PACKET PREAMBLE

(76) Inventors: Assaf KASHER, Haifa (IL); Ilan SUTSKOVER, Hadera (IL); Menashe SOFFER, Katzir (IL)

Correspondence Address: PEARL COHEN ZEDEK LATZER, LLP, 1500 BROADWAY, 12TH FLOOR, NEW YORK, NY, 10036, US

(21) Appl. No.: 12/476,328

(22) Filed: Jun. 2, 2009

Related U.S. Application Data
(60) Provisional application No. 61/188,382, filed on Aug. 8, 2008.

(51) Int. Cl. H04L 27/20; H04L 27/00

(52) U.S. Cl. 375/308; 375/295

(57) ABSTRACT

A wireless communication device, a wireless communication system and a method for transmitting a packet preamble of signal sequences to both a single carrier wireless device and a multiple carrier wireless device. The packet preamble includes a first sequence for detecting a signal and a second sequence for estimating a channel.

### BACKGROUND OF THE INVENTION

A personal wireless area network (WPAN) is a network used for communication among computing devices (for example, personal devices such as telephones and personal digital assistants) close to one person (the devices may or may not belong to that person). The reach of a WPAN may be a few meters. WPANs may be used for interpersonal communication among personal devices themselves, or for connecting via an uplink to a higher level network, for example the Internet.

The IEEE 802.15.3 Task Group 3c (TG3c) was formed in March 2005. TG3c is developing a millimeter-wave (mmWave) based alternative physical layer (PHY) for the existing 802.15.3 Wireless Personal Area Network (WPAN) Standard e.g., IEEE 802.15.3-2003. This mmWave WPAN may operate in a band including the 57-64 GHz unlicensed band defined by FCC 47 CFR 15.255 and other regulatory bodies and may be referred to as “600 Hz”. The millimeter-wave WPAN may allow very high data rate (e.g., over 2 Gigabit per second (Gbps)) applications such as high speed Internet access, streaming content download (e.g., video on demand, high-definition television (HDTV), home theater, etc.), real time streaming and wireless data bus for cable replacement.

However, an mmWave communication link is significantly less robust than links operating at lower frequencies (e.g. 2.40 Hz and 5 GHz bands) due to the Friis transmission equation, oxygen absorption and high attenuation through obstructions. In addition, the mmWave communication link may use a directional antenna and/or antennas array to increase the communication range. The use of a directional antenna makes a link very sensitive to mobility. For example, a slight change in the orientation of the device or the movement of a nearby object and/or person may disrupt the link.

60 GHz communication standards tend to have both orthogonal frequency-division multiplexing (OFDM) and single carrier (SC) physical layers. In some standards only one of the OFDM or the SC is mandatory, and in some other standards neither of OFDM and SC is mandatory. In systems having both OFDM and SC most of the time different preambles are used for each type of modulations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof may best be understood by reference to the following detailed description when read with the accompanied drawings in which;

FIG. 1 is a schematic illustration of a wireless communication network according to exemplary embodiments of the present invention;

FIG. 2 is a schematic illustration of a packet preamble according to exemplary embodiment of the invention; and

FIG. 3 is a block diagram of a wireless communication device according to some embodiments of the present invention;

FIG. 4 is a schematic illustration of flowchart of a method of transmitting a packet preamble according to some exemplary embodiments of the invention; and

FIG. 5 is a block diagram of a system according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more then one. The term plurality, as used herein, is defined as two, or more than two. The term another, as used herein is defined as at least a second or more. The terms including and/or having, as used herein, are defined as, but not limited to, comprising. The term coupled as used herein, is defined as operably connected in any desired form for example, mechanically, electronically, digitally, directly, by software, by hardware and the like.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, wireless personal network (WPAN), and the like.

Types of WPAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (ODM) and the like.

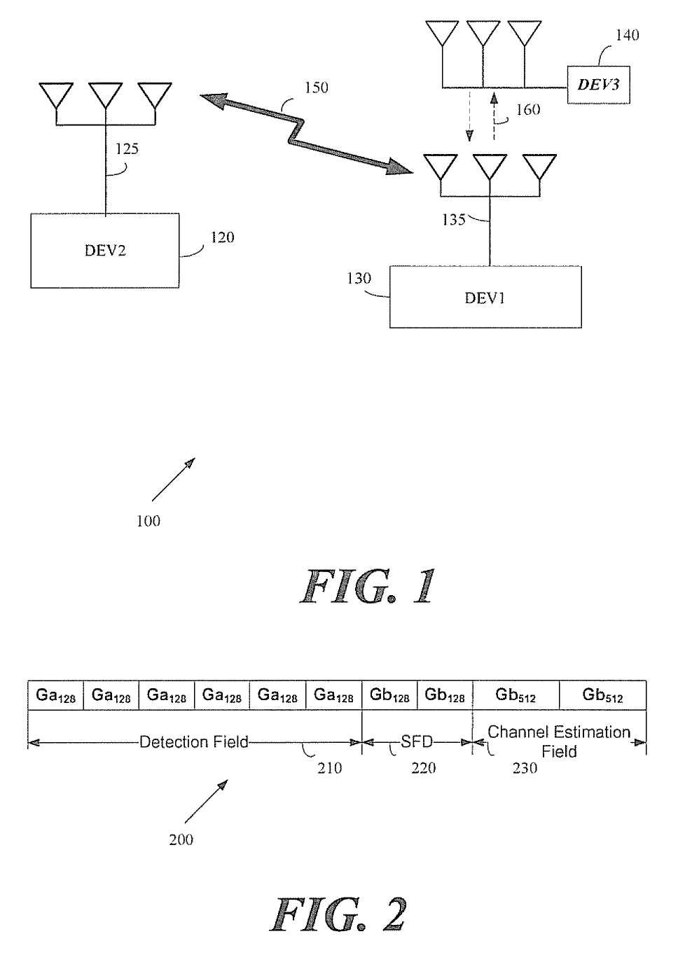

Turning first to FIG. 1, a schematic illustration of a wireless communication network 100, according to exemplary embodiments of the invention is shown. Wireless communication network 100 may include for example, a WPAN/WLAN. For example, wireless communication network 100 may operate according to the standard developed by the IEEE 802 802.11 Task Group ad (TGad). TGad is developing an Enhancements for Very High Throughput in the 60 GHz Band for WLAN

According to this exemplary embodiment of the invention, wireless communication network 100, for example a WPAN, may include stations 120, 130 and 140. Stations 120, 130 140 are depicted as devices (DEVs) e.g., DEV1, DEV2 and DEV3, respectively. Although the scope of the present invention is not limited in this respect, stations 120, 130 and 140 may include a camera, a mouse, an earphone, a speaker, a display, a mobile personal device or the like. Furthermore, each of DEV1, DEV2 and DEV3 may serve at and/or be a part of another WPAN, if desired.

According to this exemplary embodiment of the invention, DEV1 130 and DEV2 120 may transmit and receive OFDM signals and/or single carrier (SC) signals via a direct link 150, if desired. According to some embodiments of the invention a direct link may be a wireless link between two devices without the intervention of another device and/or base station and/or network controller or the like. For example, DEV3 140 may transmit a packet preamble which includes plurality of sequences via a direct link 160 to DEV1 160. DEV1 130 may transmit the preamble packet to DEV2 120 via a direct link 150, if desired.

According to at least one embodiment of the invention, the same preamble packet may be transmitted and detected by both SC devices and multiple carrier devices (e.g., OFDM), although the scope of the present invention is not limited in this respect.

Turning to FIG. 2, a schematic illustration of a packet preamble 200 according to exemplary embodiment of the invention is shown. According to embodiments of the invention packet preamble 200 may be used for both multiple carrier scheme transmissions SC scheme transmissions for example, OFDM and for SC transmissions, if desired. According to one example embodiment, packet preamble 200 may include a detection field 210, a synchronization field (SFD) 220, and a channel estimation field 230.

According, to some exemplary embodiments of the invention, the preamble portion of the packet 200 may be used for, for example, automatic gain control (AGC), signal detection, frequency offset estimation, synchronization and channel estimation. The detection. AGC and frequency offset estimation (FOE) may be done on periodic sequences. According to some exemplary embodiments, packet 200 may be based on π/2-BPSK sequences that may be used by SC receivers.

For example, detection field 210 may be made up of a repetition of a sequence with good cross correlation properties. According to embodiments of the invention, a sequence with a desired cross correlation property may be defined as a sequence whose cross correlation (either periodic or a-periodic) with its sequence having a large peak and many zeros around the peak. Non-limiting examples for sequences with the desired correlation property are pseudorandom number (PN) sequences, complementary (Golay) sequences, barker codes, a Constant Amplitude Zero AutoCorrelation (CAZAC) sequences and the like. SFD 220 may include the sequence used for the detection and selection of the transmitted modulation. For example, an inversion of the sequence used for detection or modulation of group of these sequences.

In some other embodiments of the invention SFD 220 may be omitted and its tasks may be performed by channel estimation field 230. Channel estimation field 230 may include sequences including either a long PN sequence or a pair of complementary (Golay) sequences, although the scope of the present invention is not limited in this respect.

According to exemplary embodiments of the invention, preamble packet 200 of signal sequences may be transmitted to both a single carrier wireless device and a multiple carrier wireless device. According to one example, a preamble of a packet may include a first sequence for detecting a signal (e.g., sequences of detection field 210), a second sequence for detecting and selecting a transmitter modulation (e.g. sequences of SFD 220) and a third sequence for estimating a channel (e.g., sequences of channel estimation field 230). The first, second mid third sequences may be modulated by 2/π Binary Phase Shift Keying (BPSK) modulation, if desired. It should be understood that other modulation schemes may be used with some other embodiments of the invention.

According to one exemplary embodiment of the invention, preamble packet 200 may be transmitted by an SC transmitter. In this case, the first sequence, the second sequence and the third sequence may be filtered by a pulse shaping filter. In other embodiments of the invention, preamble packet 200 may be transmitted by a multiple carrier transmitter for example, an OFDM transmitter. In this case the first, second and third sequences may be resampled by a filter known to the receiver as for example described in the following equations:

Firstly the first, second and third sequences may be resampled resample according to the following equation:

$${r}_{Preamble}^{O F D M ( 2 )} ( n ) = \{ \begin{matrix}{r}_{preamble} ( t ) & n = 0 , 3 , 6 … 3 t \\ 0 & otherwise\end{matrix} \qquad equation 1$$

which may implement adding two zeros after each sample. Secondly the first, second and third sequences may be filtered by a filter known to the receiver h_{Fih} for example decimation filter as depicted by the following equation (other equations may be used):

$${r}_{preamble}^{∼ O F D M ( 2 )} ( n ) = {\sum }_{k = 0}^{K - 1} {r}_{preamble}^{O F D M ( 2 )} ( {( n - k )}_{s} ) {h}_{Filt} ( k ) . \qquad equation 2$$

Thirdly, decimation may be performed on the first, second and third sequences by a factor of 2, taking every second sample as depicted in the following equation:

$${r}_{preamble}^{O F D M} ( n ) = {\tilde{r}}_{preamble}^{O F D M ( 2 )} ( 2 n ) , n = 0 , 1 , … . \qquad Equation 3.$$

In digital signal processing art the term “decimation” and its derivative may be defined as a technique for reducing the number of samples in a discrete-time signal and/or sequence. Decimation may include low-pass anti-aliasing filtering and downsampling of the signal, although the scope of the present invention is not limited in this respect.

According to this example, it is assumed that the OFDM (nominal) sampling rate is 1½, the chip rate of the SC for providing guard bands around the OFDM data subcarriers. The above is also applicable for other ratios between the OFDM sample rate and SC chip rate. In the receiver, detection can be done by a combination of autocorrelation and cross correlation. Efficient algorithms for correlation exist for m-sequences (PN-sequences) and complementary (Golay) sequences, if desired.

Although the scope of the present invention is not limited in this respect, receiving said preamble packet may be done either in a single carrier receiving scheme or in a multiple carrier receiving scheme, if desired. A receiver able to operate in both SC and OFDM may receive the preamble packet and decode the first, second and third sequences.

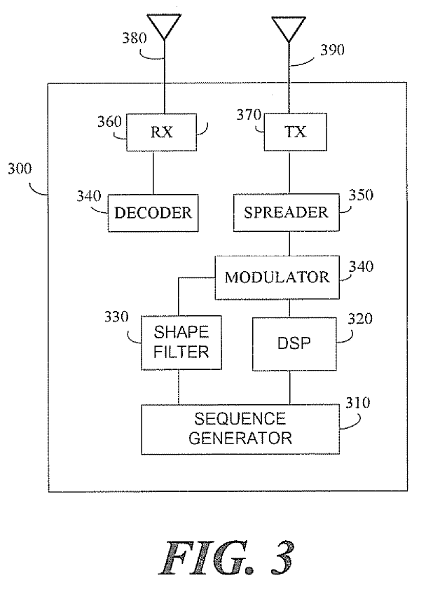

Turning to FIG. 3 a block diagram of a wireless communication device according to some embodiments of the present invention is shown. According to this exemplary embodiment, wireless communication device 300 may include a sequence generator 310, a digital signal processor (DSP) 320, a shape filter 330, a modulator 340, a receiver (RX) 360, a transmitter (TX) 370 and a plurality of antennas 380, 390.

According to exemplary embodiment of the invention, RX 360 and TX 370 may be a part of Multiple-Input-Multiple-Output (MIMO) transmitters-receivers system (not shown). According to this example RX 360 and/or TX 370 may include two or more receivers and two or more transmitters, respectively and antennas 380 and 390 may include plurality of antennas and may be operably coupled to the MIMO transmitters-receivers systems, although the scope of the present invention is not limited in this respect. According to some exemplary embodiments of the invention antennas 380 and/or 390 may include one or more antennas. For example, antennas 380 and/or 390 may include directional antennas, an antenna array, a dipole antenna or the like.

According to some embodiments of the invention, wireless communication device 300 may operate in a millimeter-wave WPAN as both, SC device and/or OFDM device, if desired. For example, wireless communication device may operate as follows. Sequence generator 310 may generate signal sequences for a preamble packet, for example preamble packet 200. Sequence generator 310 may generate the first sequence from repetition of a cross correlated sequence for example, pseudorandom number (PN) sequences, Golay sequences, barker codes and the like. Sequence generator 310 may generate the second sequence by an inversion of the first sequence and may generate the third sequence from a pair of complementary Golay sequences, if desired. Modulator 340 may modulate the first, second and third sequences by 2/π Binary Phase Shift Keying (BPSK) modulation, if desired

TX 370 may transmit the same preamble packet of signal sequences to both a single carrier wireless device and/or a multiple carrier wireless device. The preamble packet e.g., preamble packet 200, may include detection field. SFD field and a channel estimation field. The detection field may include the first sequence which may be used by RX 360 for detecting a signal or for a frequency offset estimation. The SFD field may include the second sequence that may be used by RX 360 for detecting and selecting a transmitter modulation, if desired. The channel estimation field may include the third sequence which may be used by RX 360 for estimating the channel, although the scope of the present invention is not limited to this example.

According to one exemplary embodiment of the invention, a preamble packet which is intended to be transmitted to an SC device may be filtered by shape filter 330. For example, shape filter 330 may filter an at least one of the first sequence, the second sequence and the third sequence. Modulator 340 may modulate the preamble packet which filtered by shape filter 320 able to modulate the preamble packet according to a single carrier modulation scheme.

According to one other exemplary embodiment of the invention, a preamble packet is which intended to be transmitted to OFDM device may be processed by DSP 320. For example, DSP 320 may use a three step process, if desired. The first step may be processing the first, second and third sequences of the preamble packet by adding two zeros between two samples and interpolating the first, second and third sequences by three. The second step may be filtering the first, second and third sequences by a decimation filter and the third step may be sampling the first, second and third sequences every one second and decimating the samples by two. Modulator 340 may modulate the preamble packet which is processed by DSP 320 according to a multiple carriers modulation scheme although the scope of this present invention is not limited in this respect.

Furthermore, the preamble packet may be spreaded by spreader 350 and may be transmitted by TX 370 and antenna 390, if desired. In the receiving device, antenna 380 and RX 360 may receive the sequences of the preamble packet either by a single carrier receiving scheme or by a multiple carriers receiving scheme. Decoder 340 may decode the first, second and third sequences, if desired. After decoding the sequences, synchronization may be done by correlation. Channel estimation may be done either by correlation in the time domain or in the frequency domain by dividing the transmitted sequence frequency response. It should be understood that the same preamble packet is used for both SC and OFDM and the preamble may be defined by resampling the π/2 BPSK sequences using a filter known to the receiver.

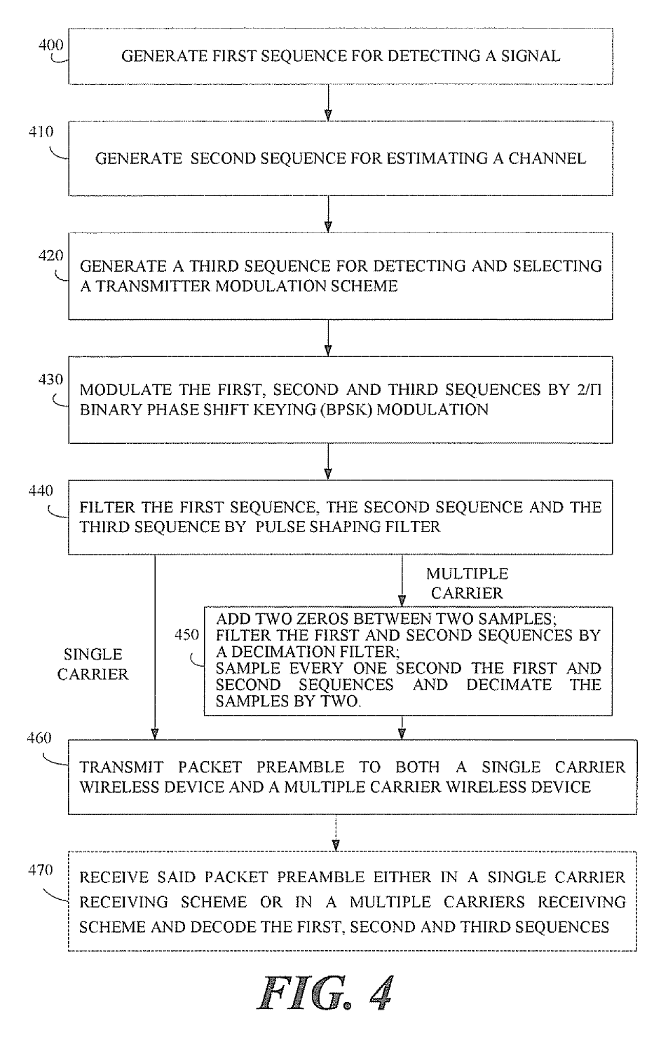

Turning to FIG. 4 a schematic illustration of flowchart of a method of transmitting a packet preamble according to some exemplary embodiments of the invention is shovel. Although the scope of the present invention is not limited to this respect the method may start by generating fields of preamble sequences that suitable to be received by both a signal carrier receiver and a multiple carrier receiver e.g., an OFDM receiver and/or by a device having both a SC receiver and an OFDM receiver.

According to this example, the method may start by generating a first sequence for detecting a signal (text block 400), generating a second sequence for estimating a channel (text box 410) and generating a third sequence for detecting and selecting a transmitter modulation scheme (text block 420).

According to this exemplary embodiment, the first sequence may be generated by repetition of a sequence having a desired cross correlation properties for example, pseudo random sequences Baker codes and the like. The third sequence may inversion of the first sequence, although the scope of the present invention is not limited to this example.

The method may continue with modulating the first, second and third sequences by for example π/2 Binary Phase Shift Keying (BPSK) modulation (text block 440) and filtering an at least one of the first sequence, the second sequence and the third sequence by a pulse shaping filter (text block 440).

In the case that the packet preamble is intendment to be received by a multiple carrier receiver, the packet preamble may be further processed by adding for example two zeros between two samples, filtering the first and second sequences by a decimation filter and sampling the first and second sequences every second and decimating the samples by two, if desired (text block 450). The packet preamble of signal sequences may be transmit to both a single carrier wireless device and a multiple carrier wireless device (text block 460). The packet preamble may be received by either in a single carrier receiving scheme or in a multiple carriers receiving scheme (text block 470). The first, second and third sequences may be decoded at the receiver, although the scope of the present invention is not limited to this example.

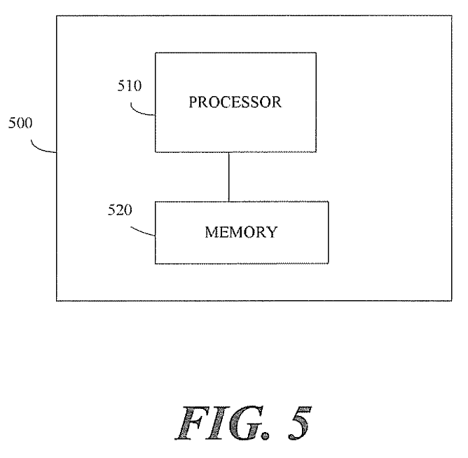

Turning to FIG. 5 a block diagram, of a system article according to embodiments of the invention is shown. Although the embodiments of the present invention are not limited to this respect, system 500 may include a computer 510 and storage medium such as a memory 520. According to exemplary embodiments of the invention system 500 may include a wireless communication device, a transmitter, a receiver and/or the like. Computer 510 may include a DSP, a processor, a controller or the like that operably coupled to memory 520. Memory 520 may be a processor readable medium, and/or a computer or processor storage medium, such as for example a memory, a disk drive, or a USB flash memory, encoding, including or storing instructions.

According to embodiments of the invention computer 510 may execute instructions store in memory 520. The instructions when executed may carry out methods disclosed herein.

While certain features of the invention have been illustrated and described herein, many modifications, substitutions changes, and equivalents will now occur to those skilled in the art. It is, therefore, to be understood that the appended claims are intended to cover all such modifications and changes as fall within the true spirit of the invention.

What is claimed is:

1. A method comprising:
transmitting a packet preamble of signal sequences to both a single carrier wireless device and a multiple carrier wireless device wherein the packet preamble includes at least a first sequence used for detecting a signal and a second sequence for estimating a channel.

2. The method of claim 1, wherein transmitting the packet preamble comprises:
generating the first sequence of repetition of a sequence having a desired cross correlation properties.

3. The method of claim 2, wherein generating the first sequence comprises:
generating the first sequence with pseudo random sequences.

4. The method of claim 2, wherein generating, the first sequence comprises:
generating the first sequence with Baker codes.

5. The method of claim 1, wherein transmitting the packet preamble comprises:
transmitting a third sequence for detecting and selecting a transmitter modulation scheme wherein, the third sequence is transmitted after the first sequence and before the second sequence.

6. The method of claim 5, wherein transmitting the third sequence comprises:
generating the third sequence with an inversion of the first sequence.

7. The method of claim 5, comprising:
modulating the first, second and third sequences by π/2 Binary Phase Shift Keying (BPSK) modulation.

8. The method of claim 5, comprising:
filtering an at least one of the first sequence, the second sequence and the third sequence by a pulse shaping filter.

9. The method of claim 1, wherein transmitting, the packet preamble comprises:
adding two zeros between two samples;
filtering the first and second sequences by a decimation filter; and
sampling the first and second sequences every one second and decimating the samples by two.

10. The method of claim 9, comprising transmitting the packet preamble according to a multiple carriers modulation scheme.

11. The method of claim 8, comprising transmitting the packet preamble according to a single carrier modulation scheme.

12. The method of claim 1 comprising:
receiving said packet preamble either in a single carrier receiving scheme or in a multiple carriers receiving scheme; and
decoding the first and second sequences.

13. A wireless communication device comprising:
a transmitter to transmit a packet preamble of signal sequences to both a single carrier wireless device and a multiple carrier wireless device, wherein the packet preamble includes a first sequence used for detecting a signal and a second sequence used for estimating a channel.

14. A wireless communication device of claim 13 wherein the transmitter transmits a third sequence for detecting and selecting a transmitter modulation wherein, the third sequence is transmitted after the first sequence and before the second sequence.

15. The wireless communication device of claim 14, comprising:
a sequence generator to generate the first sequence from repetition of a cross correlated sequence, to generate the second sequence from a pair of complementary sequences and to generate the third sequence by an inversion of the first sequence.

16. The wireless communication device of claim 13, wherein the first sequence includes a pseudo random sequence.

17. The wireless communication device of claim 13, wherein the first sequence includes a Baker codes sequence.

18. The wireless communication device of claim 14, comprising:
a modulator to modulate the first, second and third sequences by π/2 Binary Phase Shift Keying (BP SK) modulation.

19. The wireless communication device of claim 14, comprising:
a shape filter to filter an at least one of the first sequence, the second sequence and the third sequence.

20. The wireless communication device of claim 14, comprising:
a digital signal processor to:
process the first, second and third sequences of the packet preamble by adding two zeros between two samples;
filter the first, second and third sequences by a decimation filter; and
sample the first, second and third sequences every second sample and decimate the samples by two.

21. The wireless communication device of claim 18, wherein the modulator is able to modulate the packet preamble according to a multiple carriers modulation scheme.

22. The wireless communication device of claim 18, wherein the modulator is able to modulate the preamble packet according to a single carrier modulation scheme.

23. The wireless communication device of claim 14 comprising:
a receiver to receive said packet preamble either in a single carrier or in a multiple carriers; and
a decoder to decode the first, second and third sequences.

24. A wireless communication system comprising:
two or more stations, wherein a station comprises:
a transmitter to transmit a packet preamble of signal sequences to both a single carrier wireless device and a multiple carrier wireless device, wherein the packet preamble includes a first sequence for detecting a signal and a second sequence for estimating a channel.

25. A wireless communication system of claim 24 wherein the transmitter transmits a third sequence for detecting and selecting a transmitter modulation wherein, the third sequence is transmitted after the first sequence and before the second sequence.

26. The wireless communication system of claim 25, wherein the station comprises:
a sequence generator to generate the first sequence from repetition of a cross correlated sequence, to generate the second sequence from a pair of complementary sequences and to generate the third sequence by an inversion of the first sequence.

27. The wireless communication station of claim 24, wherein the first sequences includes a pseudo random sequence.

28. The wireless communication station of claim 24, wherein the first sequences includes a Baker codes sequence.

29. The wireless communication station of claim 25, wherein the station comprises:
a modulator to modulate the first, second and third sequences by π/2 Binary Phase Shift Keying (BPSK) modulation.

30. The wireless communication system of claim 25, wherein the station comprises:
a shape filter to filter an at least one of the first sequence, the second sequence and the third sequence.

31. The wireless communication system of claim 25, wherein the station comprises;
a digital signal processor to process the first, second and third sequences of the packet preamble by adding two zeros between two samples;
filtering the first, second and third sequences by a decimation filter; and
sampling the first, second and third sequences every one second and decimating the samples by two using the decimation filter.

32. The wireless communication system of claim 29, wherein the modulator is able to modulate the packet preamble according to a multiple carrier modulation scheme.

33. The wireless communication system of claim 29, wherein the modulator is able to modulate the preamble packet according to a single carrier modulation scheme.

34. The wireless communication system of claim 25, wherein the station comprises:
a receiver to receive said packet preamble either in a single carrier or in a multiple carrier; and
a decoder to decode the first, second and third sequences.
